(19) United States
(12) Patent Application Publication
(10) Pub. No.: US 2013/0110816 A1
(43) Pub. Date: May 2, 2013

(54) Default Query Rules

(71) Applicants: Sana Fahim Khan, Bellevue, WA (US); Dmitriy Meyerzon, Bellevue, WA (US); Victor Poznanski, Sammamish, WA (US); Yauhen Shnitko, Redmond, WA (US)

(72) Inventors: Sana Fahim Khan, Bellevue, WA (US); Dmitriy Meyerzon, Bellevue, WA (US); Victor Poznanski, Sammamish, WA (US); Yauhen Shnitko, Redmond, WA (US)

(73) Assignee: MICROSOFT CORPORATION, Redmond, WA (US)

(21) Appl. No.: 13/287,999

(22) Filed: Nov. 2, 2011

(51) Int. Cl. G06F 17/30

(52) U.S. Cl. 707/711; 707/722; 707/E17.108; 707/E17.14

(57) ABSTRACT

Systems and methods for reformulating an initial search query and presenting query results in a logical and user-friendly manner. Enterprise queries are detected and automatically reformulated such that a user need not have any knowledge of how to reformulate a particular query. Query results are formatted and presented such that standard browsing behavior of the user is not substantially altered. The user is made aware of how the query has been reformulated, and how to get more results of that type without changing their gaze patterns.

### CROSS REFERENCE TO RELATED APPLICATION

This application is related to U.S. patent application Ser. No. ______, Attorney Docket No. 14917.1951US01, entitled “ROUTING QUERY RESULTS,” filed ______, the entirety of which is hereby incorporated by reference.

### BACKGROUND

Enterprises typically have an abundance of information of different types and genres. One issue related to locating information of interest in an enterprise implementation stems from the fact that many users do not know how to focus a query and/or properly build an efficient query to access information of interest. This is because they may not be aware of advanced query syntax or how to refine a query. In this manner, many users cannot fully leverage the abundance of information to suit a particular task at hand.

### SUMMARY

In one aspect, a computer-implemented method for reformulating an initial search query and presenting search query results is disclosed. The method includes: receiving, at an application executing on a first computing device, a search string comprising at least one key term; comparing the at least one key term against a plurality of query rules, wherein each of the plurality of query rules includes a plurality of parameters identifying a potential type of the at least one key term; generating a plurality of queries based on the potential type of the at least one key term, wherein each one of the plurality of queries includes at least one query expression; sending each one of the plurality of queries to at least one information source for evaluation of a corresponding at least one query expression against information accessible to the at least one information source; receiving a plurality of query results, wherein each one of the plurality of query results includes a result classification identifying a type of a corresponding query result; and sending at least one of the plurality of query results to a second computing device in a networked computing environment for rendering within an interface executing thereon.

In another aspect, a computing device including a processing unit and a system memory connected to the processing unit is disclosed. The system memory includes instructions that, when executed by the processing unit, cause the processing unit to implement a mapping module, results module, and a web part module configured for reformulating an initial search query and presenting search query results. The mapping module is configured to: compare at least one key term against a plurality of query rules, wherein each of the plurality of query rules include a plurality of parameters identifying a potential type of the at least one key term; generate a plurality of queries based on the potential type of the at least one key term, wherein each one of the plurality of queries include at least one query expression; and send each one of the plurality of queries to at least one information source for evaluation of a corresponding at least one query expression against information accessible to the at least one information source. The results module is configured to: receive a plurality of query results, wherein each one of the plurality of query results include a result classification identifying a type of a corresponding query result. The web part module is configured to: send at least one of the plurality of query results to a second computing device in a networked computing environment for rendering within an interface executing thereon.

In yet another aspect, a computer-readable storage medium having computer-executable instructions is disclosed that, when executed by a first computing device, cause the first computing device to perform steps including: receive, at an application executing on the first computing device, a search string comprising at least one key term; compare the at least one key term against a plurality of query rules, wherein each of the plurality of query rules include a plurality of parameters identifying a potential type of the at least one key term, wherein the potential type of the at least one key term is selected from the group comprising: document type; uniform resource locator type; and user contact information type; generate a plurality of queries based on the potential type of the at least one key term, wherein each one of the plurality of queries include at least one query expression; send each one of the plurality of queries to at least one information source for evaluation of a corresponding at least one query expression against information accessible to the at least one information source, wherein the at least one information source is selected from the group comprising: an index associated with the application; and a web search engine; receive a plurality of query results, wherein each one of the plurality of query results comprise a results table and include a result classification identifying a type of a corresponding query result; and send at least one of the plurality of query results to a second computing device in a networked computing environment for rendering within an interface executing thereon.

This Summary is provided to introduce a selection of concepts, in a simplified form, that are further described below in the Detailed Description. This Summary is not intended to be used in any way to limit the scope of the claimed subject matter. Rather, the claimed subject matter is defined by the language set forth in the Claims of the present disclosure.

### BRIEF DESCRIPTION OF THE DRAWINGS

FIG. 1 shows an example networked computing environment.

FIG. 2 shows the example server device of FIG. 1 in detail.

FIG. 3 shows example logical modules of the client device of FIG. 1.

FIG. 4 shows example communications between example computing devices for reformulating an initial search query and presenting query results.

FIG. 5 shows a flowchart of an example for reformulating an initial search query and presenting query results.

FIG. 6 shows an example interface for entering a search query and viewing query results.

### DETAILED DESCRIPTION

The present disclosure is directed towards systems and methods for reformulating an initial search query and presenting query results in a logical and user-friendly manner.

In one example embodiment, default enterprise queries are provided based on pre-defined query rules and automatically reformulated such that a user need not have any knowledge of how to reformulate a particular query. The query rules are “pre-defined” in that they are shipped with a software product that implements the systems and methods of the present disclosure. In this manner, the query rules are supplied “out-of-the-box” and do not require any user intervention. Additionally, query results are formatted and presented such that standard browsing behavior of the user is not substantially altered. The user is made aware of how the query has been reformulated, and how to get more results of that type without changing their gaze patterns.

Although not so limited, an appreciation of the various aspects of the present disclosure will be gained through a discussion of the examples provided below.

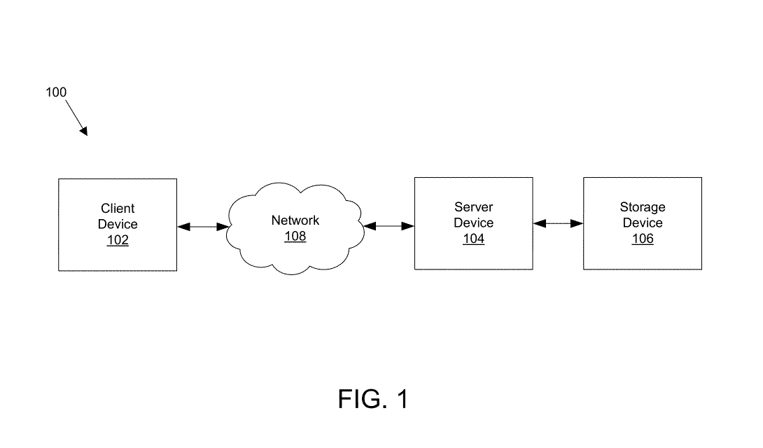

Referring now to FIG. 1, an example networked computing environment 100 is shown in which aspects of the present disclosure may be implemented. The networked computing environment 100 includes a client device 102, a server device 104, a storage device 106, and a network 108. Other embodiments are possible. For example, the networked computing environment 100 may generally include more or fewer devices, networks, and/or other components as desired.

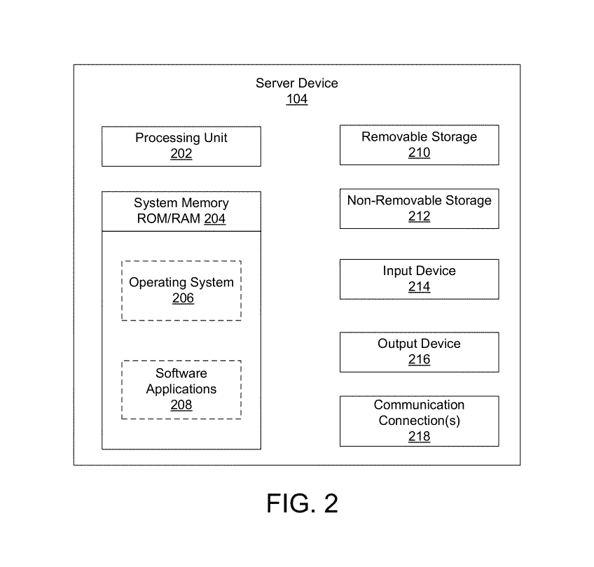

The client device 102 and the server device 104 are computing devices, as described in further detail below in connection with FIG. 2. In example embodiments, the client device 102 is configured for accessing and interacting with business processes implemented by the server device 104. Example business processes include messaging and communications process, collaboration processes, data management processes, and others. SHAREPOINT® collaboration server from Microsoft Corporation of Redmond, Wash. is an example of a business server that implements business processes in support of collaboration processes, as well as file sharing and web publishing. Other embodiments are possible.

In some embodiments, the server device 104 includes of a plurality of interconnected, networked devices operating together in a “Farm” configuration. In such a scenario, the networked devices provide a “cloud” computing platform in which one or more applications and data are hosted for one or more clients connected to the cloud computing platform. Still other embodiments are possible.

The storage device 106 is an electronic data storage device, such as a relational database or any other type of persistent data storage device. The storage device 106 stores data in a predefined format such that the server device 104 can query, modify, and manage data stored thereon. Example data includes information related to directory services, authentication services, administration services, and other services such as managed by the ACTIVE DIRECTORY® directory service from Microsoft Corporation. Other embodiments are possible.

The network 108 is a bi-directional data communication path for data transfer between one or more devices. In the example shown, the network 108 establishes a communication path for data transfer between the client device 102 and the server device 104. The network 108 can be of any of a number of wireless or hardwired WAN, LAN, Internet, Intranet, or other packet-based communication networks such that data can be transferred among the elements of the example networked computing environment 100.

Referring now to FIG. 2, the server device 104 of FIG. 1 is shown in detail. As mentioned above, the server device 104 is a computing device. An example computing device includes a server computer, desktop computer, laptop computer, personal data assistant, smartphone, gaming console, and others.

The server device 104 includes at least one processing unit 202 and a system memory 204. The system memory 204 stores an operating system 206 for controlling the operation of the server device 104 or another computing device. One example operating system is the WINDOWS® operating system from Microsoft Corporation. Other embodiments are possible.

The system memory 204 includes one or more software applications 208 and may include program data. Software applications 208 may include many different types of single and multiple-functionality programs, such as a server program, an electronic mail program, a calendaring program, an Internet browsing program, a spreadsheet program, a program to track and report information, a word processing program, and many others. One example program is the Office suite of business applications from Microsoft Corporation. Another example program includes SHAREPOINT® collaboration server, also from Microsoft Corporation of Redmond, Wash. Still other programs are possible.

The system memory 204 is computer-readable media. Examples of computer-readable media include computer-readable storage media and communication media. Computer-readable storage media is physical media that is distinguished from communication media.

The phrase “computer-readable” generally refers to information that can be interpreted and acted on by a computer or computing device. The phrase “storage media” or, equivalently, “storage medium” refers to the various types of physical or tangible material on which electronic data bits are written and stored. Since it is not possible to store information in a transient signal, “computer-readable storage media” as defined within the context of the present disclosure excludes transient signals.

Computer-readable storage media includes physical volatile and nonvolatile, removable and non-removable media implemented in any method or technology for storage of information, such as computer-readable instructions, data structures, program modules, or other data. Computer storage media also includes, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the server device 104. Any such computer storage media may be part of or external to the server device 104. Such storage is illustrated in FIG. 2 by removable storage 210 and non-removable storage 212.

Communication media is typically embodied by computer-readable instructions, data structures, program modules, or other data, in a transient modulated data signal, such as a carrier wave or other transport mechanism, and includes any information delivery media. The term “modulated data signal” refers to a signal that has one or more of its characteristics set or changed in such a manner as to encode information in the signal. By way of example, communication media includes wired media such as a wired network or direct-wired connection, and wireless media such as acoustic, RF, infrared and other wireless media.

The server device 104 also includes any number and type of an input device 214 and an output device 216. An example input device 214 includes a keyboard, mouse, pen, voice input device, touch input device, motion input device, and others. For example, the input device 214 may be a camera operative to capture and record motions and/or gestures made by a user. The input device 214 may be further operative to capture words spoken by a user, such as by a microphone, and/or capture other inputs from user such as by a keyboard and/or mouse. Consistent with embodiments of the present disclosure, the input device 214 may comprise any motion detection device capable of detecting the movement of a user. For example, the input device 214 may comprise a KINECT® motion capture device, from Microsoft Corporation. Other embodiments are possible.

An example output device 216 includes a display, speakers, printer, and others. The server device 104 also includes a communication connection 218 configured to enable communications with other computing devices over a network (e.g., network 108 of FIG. 1) in a distributed computing system environment.

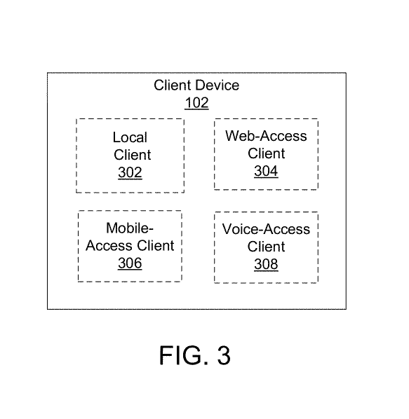

The client device 102 of FIG. 1 is also a computing device configured in a manner similar to that of the server device 104 described above. Referring now to FIG. 3, the client device 102 is also configured to include one or more different types of interfaces to the server device 104. In the example shown, the client device 102 includes a local client 302, a web-access client 304, a mobile-access client 306, and a voice-access client 308.

The local client 302 is configured as a dedicated messaging and collaboration client that serves as an interface to the server device 104, and is part of a suite of applications executing on the client device 102. In one embodiment, the local client 302 includes the OUTLOOK® messaging and collaboration client, which is an e-mail application that is part of the Office suite of business applications from Microsoft Corporation. A user can compose, interact with, send and receive e-mails with the OUTLOOK® messaging and collaboration client. Other embodiments of the local client 302 are possible. For example, in one embodiment, the local client 302 includes the Office Communicator client from Microsoft Corporation, an instant messaging client used with Office Communications Server. Still other embodiments are possible.

The web-access client 304 is configured to accesses the server device 104 remotely via a network connection, such as the Internet. In one embodiment, the web-access client 304 is the Outlook Web Access (OWA) webmail service of Exchange Server. In the example embodiment, the client device 102 uses a web browser to connect to Exchange Server via Outlook Web Access. This brings up a user interface similar to the interface in the OUTLOOK® messaging and collaboration client in which a user can compose, interact with, send and receive e-mails. Other embodiments of the web-access client 304 are possible. For example, the web-access client 304 may be configured to connect to SHAREPOINT® collaboration server to access corresponding collaboration, file sharing and web publishing services. Still other embodiments are possible.

The mobile-access client 306 is another type of client interface to the server device 104. In one embodiment, the mobile-access client 306 includes the Mobile Access with ACTIVESYNC® synchronization technology, or the Windows Mobile Device Center for WINDOWS VISTA® operating system or Windows 7 operating system, all from Microsoft Corporation. Example mobile devices include a cellular telephone, smartphone, a personal digital assistant, and others. Other embodiments of the mobile-access client 306 are possible.

The voice-access client 308 is yet another type of client interface to the server device 104. In some embodiments, the voice-access client 308 includes Exchange Unified Messaging that is supported in Exchange Server. With Unified Messaging, users have one inbox for e-mail and voicemail. Voicemails are delivered directly into the OUTLOOK® messaging and collaboration client inbox. The message containing the voicemails may also include an attachment. Other embodiments of the voice-access client 308 are possible.

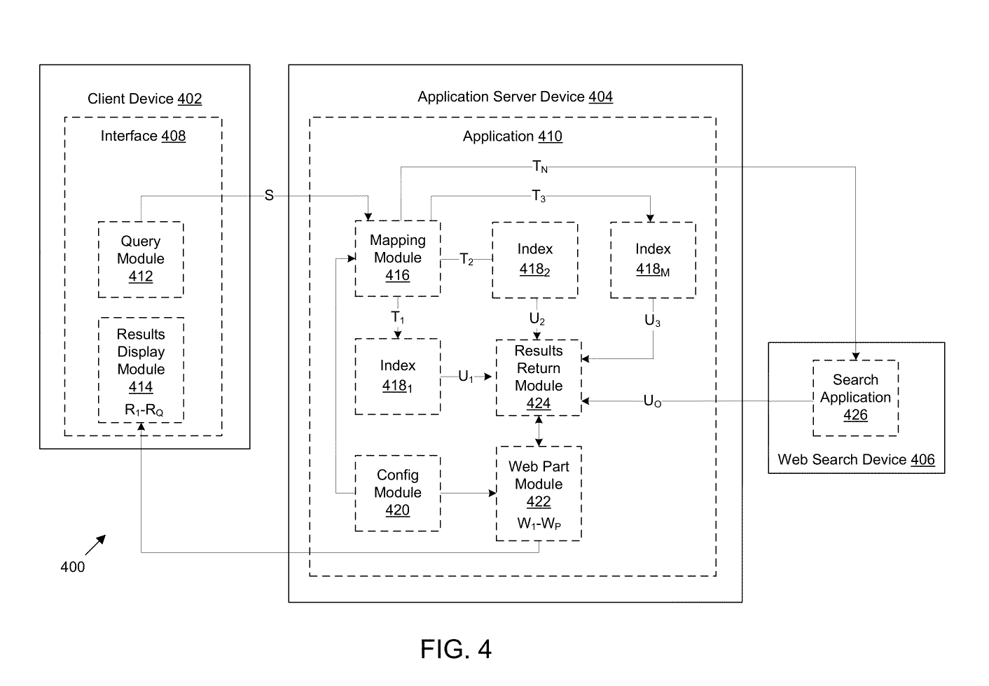

Referring now to FIG. 4, an example block diagram 400 illustrates example communications between computing devices for reformulating a search query and presenting query results in a logical and user-friendly manner in accordance with the present disclosure.

The block diagram 400 includes a client device 402, an application server device 404, and a web search device 406. Other embodiments are possible. For example, the block diagram 400 may generally include more or fewer devices and/or other components as desired.

The client device 402 is similar to the client device 102 described above, and includes an interface 408 configured for accessing and interacting with business processes implemented by an application 410 executing on the application server device 404. The application server device 404 is similar to the server device 104 described above.

The interface 408 includes a query module 412 and a results display module 414, and the application 410 includes a mapping module 416, a plurality of indexes 418_{1-M} (collectively, indexes 418), where M is an arbitrary integer value, a configuration module 420, a web part module 422, and a results return module 424. Functionality of the respective example modules of the interface 408 and application 410 are described in further detail below.

The web search device 406 is a computing device and includes a search application 426 generally configured to search, crawl, and/or index information on the World Wide Web. An example of such a search application includes the BINGO web search engine from Microsoft Corporation. Other embodiments of the search application 426 are possible.

In one example communications sequence, the query module 412 of the interface 408 receives an example string S=“RAS” from a user, and sends the string S to the mapping module 416 of the application 410. In one embodiment, the user enters the string S in the query module 412 (e.g., within a text field), and then executes a search query against the string S by engaging a selectable control (e.g., a button) within the query module 412. Other embodiments are possible.

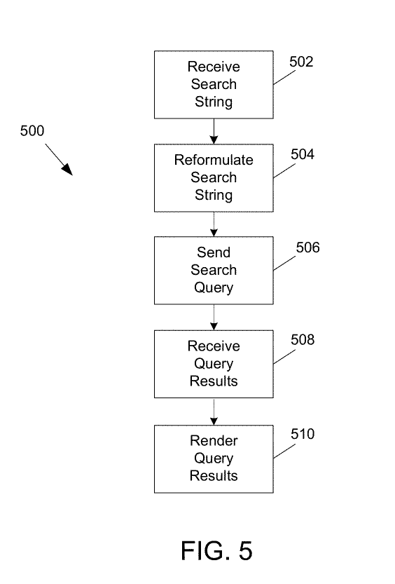

The mapping module 416 receives the string S from the query module 412, reformulates the string S into a plurality of search queries T₁-T_{N}, where N is an arbitrary integer value, and sends each one of the plurality of search queries T₁-T_{N} to at least one information source. In general, the plurality of search queries T₁-T_{N} are formed in accordance with at least one query mapping rule pre-defined via the configuration module 420 by a user (e.g., an administrator), discussed in further detail below in connection with FIG. 5.

Continuing with the example string S=“RAS”, example search query T₁=“RAS; People” may be generated by the mapping module 416 and then sent to the index 418₁, example search query T₂=“RAS; Document” may be formed and then transferred to the index 418₂, example search query T₃=“RAS; Best Bets” may be formed and then transferred to the index 418ₘ, and example search query T_{N}=“RAS; Social Media” may be constructed and then directed to the search application 426. Other embodiments are possible.

In these examples, the index 418₁ may include a plurality of contact information (e.g., name, phone number, e-mail, etc.) for a plurality of people or users associated with an enterprise, the index 418₂ may include a plurality of documents (e.g., word processing documents, presentation documents, etc.) authored or modified by the plurality of users associated with the enterprise, and the index 418_{M} may include a plurality of commonly returned results for previous search queries including one or more common terms (and variations thereof) contained within the example string S. Other embodiments are possible.

The results return module 424 of the application 410 receives a plurality of query results U₁-U_{O}, where O is an arbitrary integer value, from each of the plurality of indexes 418 and search application 426 in view of the plurality of search queries T₁-T_{N} previously being sent to the same. The web part module 422 of the application 410 then accesses the plurality of query results U₁-U_{O} within the results return module 424 and generally operates on the same.

Specifically, the web part module 422 includes a plurality of web parts W₁-W_{P}, where P is an arbitrary integer value. A web part is a re-useable software component that implements one or more controls that enable end users to view and modify content, appearance, and behavior of Web pages directly from a browser. In example embodiments, each of the plurality of web parts W₁-W_{P} accesses and evaluates each of the plurality of query results U₁-U_{O} within the results return module 424. When a given web part is compatibly configured to display at least one specific “type” of result associated with each of the respective plurality of query results U₁-U_{O}, then that particular web part renders an associated result(s) within at least one of a plurality of result sections R₁-R_{Q}, where Q is an arbitrary integer value, within the results display module 414 of the interface 408.

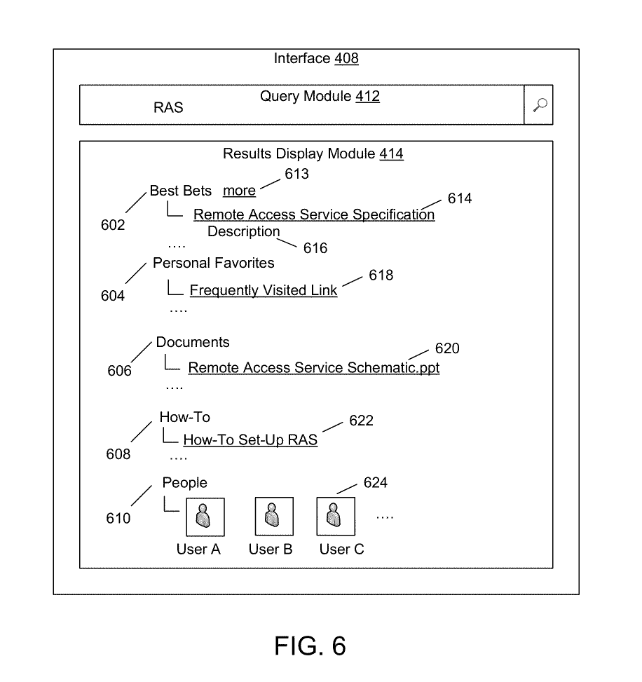

For example, assuming that the web part W₁ is configured to render a query result of “People” type, when this web part accesses and evaluates the plurality of query results U₁-U_{O} within the results return module 424, at least the query result U₁ is picked-up by the web part W₁ and rendered within at least one of a plurality of result sections R₁-R_{Q} within the results display module 414, described in further detail below in connection with FIGS. 5-6. Similarly, when respective web parts W₂-W_{P} access and evaluate each of the plurality of query results U₁-U_{O} in the results return module 424, one or more of the plurality of query results U₁-U_{O} are picked-up and rendered within at least one of a plurality of result sections R₁-R_{Q}.

Additionally, each of the plurality of web parts W₁-W_{P} may combine results of the plurality of query results U₁-U_{O} in accordance with at least one combining rule pre-defined via the configuration module 420. Example logic that can be used to concatenate or otherwise combine query results, such as by interleaving and stacking is described in U.S. patent application Ser. No. ______, the entirety of which is hereby incorporated by reference as stated above. Other embodiments are possible.

Referring now to FIG. 5, an example method 500 for reformulating a search query and presenting query results in a logical and user-friendly manner is shown. In the example embodiment, the method 500 is implemented by the application 410 executing on the application server device 404 described above in connection with FIG. 4. However, other embodiments are possible. For example, one or more modules of the application 410 may be located wholly or in part on one or more different computing devices in a “cloud” computing implementation.

The method 500 begins at a first module 502. The first module 502 is configured to receive a search string comprising at least one key term for comparison against content accessible to or by at least one information source (e.g., plurality of indexes 418_{1-M}, search application 426, etc.). Other embodiments are possible.

Operational flow then proceeds to a second module 504. The second module 504 is configured to map the search string received by the first module 502 into at least one search query in accordance with one or more configurable query mapping rules. More specifically, the second module 504 detects certain types of intent(s) associated with the search string, and reformulates the search string to handle the same.

For example, assuming an example search string=“deck”, the second module 504 is configured to identify the term “deck” as a possible “PowerPoint” document type. The search string=“deck” may then be reformulated as an example search query=“PowerPoint” for the purpose of querying and retrieving results from a document repository that at least includes documents of “PowerPoint” type. As discussed in further detail below, results associated with “PowerPoint” type are then rendered in a results block within the results display module 414 of the interface 408 of the client device 402 in an ordered or ranked manner for viewing.

An example of a plurality of query mapping rules and associated query parameters that identify a possible type of at least one key term within an example string are shown in the following table:

| Rule Name | Query Condition(s) |
|---|---|
| PowerPoint | Matches Keywords: ppt; pptm; pptx; deck(s); etc. |
| Word | Matches Keywords: doc; docm; docx; word; etc. |
| Site | Matches Keywords: webpage; homepage; site; team |
| | site; etc. |
| | Commonly Clicked Results |
| Department | Matches Dictionary: Departments |
| Excel | Matches Keywords: xls; xlsm; xlsx; excel; etc. |
| Job Title | Matches Dictionary: Job Title |
| Location | Matches Dictionary: Location |
| People Name | Matches Dictionary: People |
| Phone Number | Matches Dictionary: Contact Information |

In example embodiments, a “keywords” match is/are an explicit term match configured by a user, and “dictionaries” in some cases are automatically populated from properties defined within a dedicated database (e.g., Active Directory). Other embodiments are possible as well. For example, one or more query mapping rules can be defined to handle intent(s) related to media (e.g., video, audio), how-to's, acronyms, definitions, expertise, personal favorites, best bets, social media (e.g., LinkedIn, Facebook, etc.), discussions, and others. Additionally, parameters related to query condition(s) can be selectively defined to identify misspelled yet related key words or terms, terms in one or more languages other than English, etc. Other parameters related to query condition(s) can be selectively defined to expand a term and translate (i.e., localize) the term into an appropriate form in various languages. For example, the word “deck” might be expanded to “decks” and translated into appropriate forms in one or more other non-English languages. Still other embodiments are possible.

Operational flow then proceeds to a third module 506. The third module 506 is configured to send the at least one search query to at least one information source. In general, the information source is accessible over a network (e.g., network 108) within a networked computing environment (e.g., environment 100). Other embodiments are possible.

Operational flow then proceeds to a fourth module 508. The fourth module 508 is configured to receive a plurality of query results in view of the at least one search query sent by the third module 506. In one embodiment, each of the plurality of results is generically formatted as a results table collection, which is a set of results tables.

In general, a results table may consist of a collection of results or information arranged in a row/column format in an ordered arrangement such as, for example, results listed according to a pre-defined ranking scheme (e.g., priority, significance, confidence, etc.), or an unordered arrangement (e.g., raw data). A results table may additionally include at least one “type” associated with the same. For example, a results table including a collection of “ppt” results might be assigned as “document” type, and a results table including a collection of individual names might be assigned as “user” type and/or “author” type. Other embodiments are possible.

Operational flow then proceeds to a sixth module 510. The sixth module 510 is configured to render one or more of the plurality of query results within at least one of the plurality of results section R₁-R_{Q} within the results display module 414 of the interface 408 of the client device 402 of FIG. 4.

For example, referring now to FIG. 6, an example implementation of the interface 408 is shown in accordance with the present disclosure. In the example embodiment, the example string S=“RAS” has been entered into the query module 412, and the results display module 414 generally includes a plurality of section or blocks that display example query results retrieved in view of the string S=“RAS”. Specifically, the results display module 414 includes a best bets block 602, a personal favorites block 604, a documents block 606, a how-to block 608, a people block 610, and a discussion block 612. However, other embodiments are possible. For example, the results display module 414 may generally include more or fewer sections, blocks, or other information as desired.

In example embodiments, results blocks are displayed in a core results web part, that is, a block comprises a set of results backed by a results table. In general, blocks may be fixed (e.g., best bets block 602), or ranked (e.g., how-to block 608). Overall layout of a block is governed by a group template that includes a title, a “more” link 613, and a method for layout or display of component results. An example of a template includes a horizontal and vertical template that lays out items either horizontally or vertically across the results display module 414. An example of a “more” link includes a URL that links to a page or methods. Other embodiments are possible as shown by the following table, which includes a summary of decisions for Group and Item Templates, and “More” behavior (i.e., action(s) implemented upon selection of a “more” link:

| Intent (e.g., Rule) | Group template | Item Templates | “More” Behavior |
|---|---|---|---|
| PPT | Vertical | Powerpoint | Refiner |
| DOC | Vertical | Word | Refiner |
| PDF | Vertical | PDF | Refiner |
| XLS | Vertical | Excel | Refiner |
| Sites | Vertical | Site (with deep | Query |
| | | links) | |
| Person Name | Horizontal | PeopleCompact | People Nav + |
| | | (and regular) | ranking model |
| Popular People | Horizontal | PeopleCompact | People Nav |
| | | (and regular) | |
| Video | Horizontal | Video compact | Video Nav |
| How-to | Vertical | Site (without | Query |
| | | deep links) | |
| Social definitions | Vertical | Definition | Query |
| | | template | |
| Discussions | M3 | M3 | |
| Personal favorites | Vertical | Favorites | None |
| | | template | |
| Best Bets | Vertical | Best bet | Expand (or none) |
| | | template | |
| Upscoping | Vertical | Infer | “Everything” Nav |
| Business Reports | M3 | M3 | |

Additionally, a “Title” for a given block may be optionally defined as shown in the following table:

| Intent (e.g., Rule) | Rule Type | # Results | Title |
|---|---|---|---|
| PPT | Dictionary | 2 | PowerPoint presentations |
| | | | for “{content}” |
| DOC | Dictionary | 2 | Word documents for {content} |
| PDF | Dictionary | 2 | PDF documents results for |
| | | | {content} |
| XLS | Dictionary | 2 | Excel spreadsheets results for |
| | | | {content} |
| Sites | Dictionary | 2 | SharePoint sites for {content} |
| Person Name | {person name} | 5 | People named {query} |
| Popular People | [people] | 5 | People |
| Video | [video] | 5 | Videos for {content} |
| How-to | Dictionary/Clicked | 2 | How to . . . |
| | property | | |
| Social definitions | always | 3 | Possible definitions for {content} |
| Discussions | M3 | | |
| Personal favorites | fixed | 2 | Recommended from your past |
| | | | searches |
| Best Bets | fixed | 3 | Recommended Results |
| Upscoping | Context | 2 | Search Center Results |
| | condition = site | | |
| Business Reports | M3 | | |
| Personal Favorites | always | | Personal Favorites |
| Intent | Rule Type | # Results | Title |
| PPT | Dictionary | 2 | PowerPoint presentations for |
| | | | “{content}” |
| DOC | Dictionary | 2 | Word documents for {content} |
| PDF | Dictionary | 2 | PDF documents results for |
| | | | {content} |
| XLS | Dictionary | 2 | Excel spreadsheets results for |
| | | | {content} |
| Sites | Dictionary | 2 | SharePoint sites for {content} |
| Person Name | {person name} | 5 | People named {query} |
| Popular People | [people] | 5 | People |
| Video | [video] | 5 | Videos for {content} |
| How-to | Dictionary/Clicked | 2 | How to . . . |
| | property | | |
| Social definitions | always | 3 | Possible definitions for {content} |
| Discussions | M3 | | |
| Personal favorites | fixed | 2 | Recommended from your past |
| | | | searches |
| Best Bets | fixed | 3 | Recommended Results |
| Upscoping | Context | 2 | Search Center Results |
| | condition = site | | |
| Business Reports | M3 | | |
| Personal Favorites | always | | Personal Favorites |

The best bets block 602 includes curated results from a system administrator. Each result may include a uniform resource located (URL) linked title 614 and a description 616 (e.g., image/html). Additionally, selection of the heading “Best Bets” may navigate to a separate interface or page that lists at least a portion of a plurality of “Best Bet” results in detail, indicated by the characters “ . . . ” in FIG. 6. Other embodiments are possible.

The personal favorites block 604 includes at least one favorite result 618 including a link a user has previously repeatedly clicked for a particular result, and the documents block 606 includes at least one document result 620. Example documents include word processing documents, spreadsheet documents, presentation documents, etc.

The how-to block 608 includes at least one how-to link 622 that contains information about procedures, etc., associated with the example string S=“RAS” that might be useful within an enterprise, and the people block 610 includes at least one people link 624 that contains information about a person potentially associated with the example string S=“RAS”.

In the example shown, the at least one people link 624 is displayed in a horizontal orientation. In general, query results for each of the example results blocks of FIG. 6 may be selectively defined to be displayed in any orientation (e.g., horizontal, vertical, etc.) as desired. Additionally, selection of a particular heading (e.g., “Documents”) may navigate to a separate interface or page that lists at least a portion of a plurality of corresponding results in detail. Still other formatting related embodiments are possible.

For example, in some embodiments, an end user or administrator is enabled to selectively configure the results display module 414 and/or web part module 422 to place a particular results block in a preferred position within the results display module 414 (e.g., top, middle, bottom, etc.) and/or in preferred position in relation to other results blocks (e.g., the people block 610 may be selectively defined to be placed above the how-to block 608). Still other embodiments are possible.

For example, positioning of a particular results block within results display module 414 may be automatically adjusted in view of user habits. For example, if a user frequently selects search results from the people block 610, the people block 610 may migrate towards the top of the results display module 414 over time. Other embodiments are possible.

The example embodiments described herein can be implemented as logical operations in a computing device in a networked computing system environment. The logical operations can be implemented as: (i) a sequence of computer implemented instructions, steps, or program modules running on a computing device; and (ii) interconnected logic or hardware modules running within a computing device.

For example, embodiments of the present disclosure may be practiced via a system-on-a-chip (SOC) where each or many of the components illustrated in FIG. 2 may be integrated onto a single integrated circuit. Such an SOC device may include one or more processing units, graphics units, communication units, system virtualization units and application functionality, all of which are integrated onto a chip substrate as a single integrated circuit.

Additionally, the logical operations can be implemented as algorithms in software, firmware, analog/digital circuitry, and/or any combination thereof, without deviating from the scope of the present disclosure. The software, firmware, or similar sequence of computer instructions can be encoded and stored upon a computer readable storage medium and can also be encoded within a carrier-wave signal for transmission between computing devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for reformulating an initial search query and presenting search query results, the method comprising:
receiving, at an application executing on a first computing device, a search string comprising at least one key term;
comparing the at least one key term against a plurality of query rules, wherein each of the plurality of query rules includes a plurality of parameters identifying a potential type of the at least one key term;
generating a plurality of queries based on the potential type of the at least one key term, wherein each one of the plurality of queries includes at least one query expression;
sending each one of the plurality of queries to at least one information source for evaluation of a corresponding at least one query expression against information accessible to the at least one information source;
receiving a plurality of query results, wherein each one of the plurality of query results includes a result classification identifying a type of a corresponding query result; and
sending at least one of the plurality of query results to a second computing device in a networked computing environment for rendering within an interface executing thereon.

2. The method of claim 1, wherein the potential type of the at least one key term is selected from the group comprising: document type; uniform resource locator type; and user contact information type.

3. The method of claim 1, wherein the at least one information source is selected from the group comprising: an index associated with the application; and a web search engine.

4. The method of claim 1, wherein each of the plurality of query results comprise a results table including a collection of information arranged in a column and row format.

5. The method of claim 4, wherein a results table is an ordered collection of results.

6. The method of claim 4, wherein a results table is an unordered collection of results.

7. The method of claim 1, further comprising combining at least two of the plurality of query results into a combined query result based on the result classification of each of the at least two of the plurality of query results.

8. The method of claim 7, further comprising generating the combined query result by one of interleaving and stacking the results table of the at least two of the plurality of query results.

9. The method of claim 8, further comprising displaying the combined query result within the interface executing on the second computing device according to a pre-defined layout including at least one of a title, a description, and a link to a page including additional query results, and wherein the combined query result is selectively displayed in one of a horizontal orientation and a vertical orientation.

10. The method of claim 1, wherein each of the plurality of query rules is a pre-configured default query rule.

11. A computing device, comprising:
a processing unit; and
a system memory connected to the processing unit, the system memory including instructions that, when executed by the processing unit, cause the processing unit to implement a mapping module, results module, and a web part module configured for reformulating an initial search query and presenting search query results, wherein:
the mapping module is configured to:
compare at least one key term against a plurality of query rules, wherein each of the plurality of query rules include a plurality of parameters identifying a potential type of the at least one key term;
generate a plurality of queries based on the potential type of the at least one key term, wherein each one of the plurality of queries include at least one query expression; and
send each one of the plurality of queries to at least one information source for evaluation of a corresponding at least one query expression against information accessible to the at least one information source;
the results module is configured to:
receive a plurality of query results, wherein each one of the plurality of query results include a result classification identifying a type of a corresponding query result; and
the web part module is configured to:
send at least one of the plurality of query results to a second computing device in a networked computing environment for rendering within an interface executing thereon.

12. The computing device of claim 11, wherein the mapping module is further configured to receive a search string comprising the at least one key term.

13. The computing device of claim 11, wherein the potential type of the at least one key term is selected from the group comprising: document type a uniform resource locator type; and user contact information type.

14. The computing device of claim 11, wherein the at least one information source is selected from the group comprising: an index associated with the application; and a web search engine.

15. The computing device of claim 11, wherein each of the plurality of query results comprise a results table including a collection of information arranged in a column and row format.

16. The computing device of claim 15, wherein a results table is one of an ordered collection of results and an unordered collection of results.

17. The computing device of claim 16, wherein the web part module is further configured to combine at least two of the plurality of query results into a combined query result based on the result classification of each of the at least two of the plurality of query results.

18. The computing device of claim 17, wherein the web part module is further configured to generate the combined query result by one of stacking and interleaving the results table of the at least two of the plurality of query results.

19. The computing device of claim 18, wherein the web part module is further configured to send at least the combined query result to a second computing device for rendering within an interface executing thereon.

20. A computer-readable storage medium having computer-executable instructions that, when executed by a first computing device, cause the first computing device to perform steps comprising:
receive, at an application executing on the first computing device, a search string comprising at least one key term;
compare the at least one key term against a plurality of query rules, wherein each of the plurality of query rules include a plurality of parameters identifying a potential type of the at least one key term, wherein the potential type of the at least one key term is selected from the group comprising: document type; uniform resource locator type; and user contact information type;
generate a plurality of queries based on the potential type of the at least one key term, wherein each one of the plurality of queries include at least one query expression;
send each one of the plurality of queries to at least one information source for evaluation of a corresponding at least one query expression against information accessible to the at least one information source, wherein the at least one information source is selected from the group comprising: an index associated with the application; and a web search engine;
receive a plurality of query results, wherein each one of the plurality of query results comprise a results table and include a result classification identifying a type of a corresponding query result; and
send at least one of the plurality of query results to a second computing device in a networked computing environment for rendering within an interface executing thereon.
